(19) United States
(12) Patent Application Publication
(10) Pub. No.: US 2022/0066458 A1
(43) Pub. Date: Mar. 3, 2022

(54) PLANNING SYSTEM, PLANNING METHOD, AND PROGRAM

(71) Applicant: Toyota Jidosha Kabushiki Kaisha, Toyota-shi Aichi-ken (JP)

(72) Inventors: Kunihiro Iwamoto, Nagakute-shi (JP); Yuta Itozawa, Nagoya-shi (JP); Hirotaka Komura, Anjo-shi (JP)

(73) Assignee: Toyota Jidosha Kabushiki Kaisha, Toyota-shi Aichi-ken (JP)

(21) Appl. No.: 17/411,741

(22) Filed: Aug. 25, 2021

(30) Foreign Application Priority Data
Aug. 27, 2020 (JP) 2020-143267

(51) Int. Cl. G05D 1/02; G05D 1/00; G06Q 50/26

(52) U.S. Cl. CPC G05D 1/0219; G05D 1/0246; G05D 2201/0217; G06Q 50/26; G05D 1/0088

(57) ABSTRACT

A planning system, a planning method, and a program capable of efficiently collecting collection target objects are provided. The planning system is a system for making a plan to collect collection target objects from a collection site, and includes: an information acquisition unit configured to acquire, using a sensor, collection target object information, which is information regarding the types and the amounts of the collection target objects that are present in the collection site; and a plan generation unit configured to generate a plan to collect the collection target objects based on the collection target object information.

### CROSS REFERENCE TO RELATED APPLICATIONS

This application is based upon and claims the benefit of priority from Japanese patent application No. 2020-143267, filed on Aug. 27, 2020, the disclosure of which is incorporated herein in its entirety by reference.

### BACKGROUND

The present disclosure relates to a planning system, a planning method, and a program, and relates to, in particular, planning for collecting collection target objects.

Japanese Unexamined Patent Application Publication No. 2014-201424 discloses a garbage collection system that collects garbage from a plurality of homes by a garbage collecting robot that autonomously travels. In this garbage collection system, the garbage collecting robot moves to a collection destination based on reservation information for collection transmitted from a resident's terminal. Further, in this garbage collection system, foreign substances (metal) included in garbage are detected by a sensor mounted on a bed of the garbage collecting robot, whereby mixture of the foreign substances in the collected garbage can be broadcasted.

### SUMMARY

While Japanese Unexamined Patent Application Publication No. 2014-201424 discloses a system for achieving automatic collection, efficiency of collection based on information on the collection target has not been taken into account. In this system, in particular, although certain types of objects contained in garbage are detected, the result of the detection is merely broadcasted and is not used to improve collection efficiency.

The present disclosure has been made in view of the aforementioned circumstances and aims to provide a planning system, a planning method, and a program capable of efficiently collecting collection target objects.

An aspect of the present disclosure to accomplish the aforementioned object is a planning system for making a plan to collect collection target objects from a collection site, the planning system including: an information acquisition unit configured to acquire, using a sensor, collection target object information, which is information regarding the types and the amounts of the collection target objects that are present in the collection site; and a plan generation unit configured to generate a plan to collect the collection target objects based on the collection target object information.

According to the above planning system, a collection plan in view of information regarding collection target objects is generated. Therefore, an efficient collection of collection target objects in accordance with the type or the amount thereof can be achieved.

In the above aspect, the information acquisition unit may acquire the collection target object information for each collection site, and the plan generation unit may generate a collection route for collecting the same type of collection target objects based on the collection target object information.

According to the above structure, a collection route in view of information regarding the collection target objects at each collection site is generated. Therefore, it is possible to perform efficient movement for collection.

In the above aspect, the plan generation unit may determine, based on the collection target object information, the type of a transport apparatus that is used to collect the collection target objects, the transport apparatus moving to the collection site and transporting the collection target objects collected from the collection site.

According to the above structure, the type of the transport apparatus is determined in view of information regarding the collection target objects. Therefore, collection may be performed using an appropriate transport apparatus.

In the above aspect, the plan generation unit may determine which one of a plurality of types of transport apparatuses with different transport volumes should be used.

According to the above structure, collection may be performed using a transport apparatus with an appropriate transport volume.

In the above aspect, the plan generation unit may determine which one of a plurality of types of transport apparatuses that perform different processing on the collection target objects loaded on the transport apparatuses should be used.

According to the above structure, collection may be performed using a transport apparatus including an appropriate processing function.

In the above aspect, the plan generation unit may determine, based on the collection target object information, the number of transport apparatuses that are used to collect the collection target objects, the transport apparatuses moving to the collection site and transporting the collection target objects collected from the collection site.

According to the above structure, the number of transport apparatuses is determined in view of the information regarding the collection target objects. Therefore, collection may be performed using an appropriate number of transport apparatuses.

In the above aspect, the plan generation unit may determine, based on the collection target object information, the frequency with which the collection target objects are collected.

According to the above structure, collection may be performed at an appropriate frequency.

In the above aspect, the sensor may be mounted on an autonomous mobile robot that moves in a range including the collection site.

According to the above structure, even when equipment for transmitting information regarding the collection target objects is not provided in each collection site, it is possible to acquire this information.

In the above aspect, the sensor may include an image sensor, and the types of the collection target objects may be determined using the image sensor.

According to the above structure, it is possible to easily specify the types of the collection target objects.

Another aspect of the present disclosure to accomplish the aforementioned object is a planning method in which an information processing apparatus makes a plan to collect collection target objects from a collection site, the method including: acquiring, using a sensor, collection target object information, which is information regarding the types and the amounts of the collection target objects that are present in the collection site; and generating a plan to collect the collection target objects based on the collection target object information.

According to this planning method, a collection plan in view of information regarding the collection target objects is generated. Therefore, an efficient collection of collection target objects in accordance with the types or the amount thereof can be achieved.

Another aspect of the present disclosure to accomplish the aforementioned object is a program for causing a computer that makes a plan to collect collection target objects from a collection site to perform the following: acquiring, using a sensor, collection target object information, which is information regarding the types and the amounts of the collection target objects that are present in the collection site; and generating a plan to collect the collection target objects based on the collection target object information.

According to the above program, a collection plan in view of information regarding the collection target objects is generated. It is therefore possible to perform efficient collection in accordance with the types or the amounts of the collection target objects.

According to the present disclosure, it is possible to provide a planning system, a planning method, and a program capable of efficiently collecting collection target objects.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic view showing one example of a system configuration of a collection system according to an embodiment;

FIG. 2 is a block diagram showing one example of a functional configuration of a planning apparatus according to the embodiment;

FIG. 3 is a block diagram showing one example of a hardware configuration of the planning apparatus according to the embodiment; and

FIG. 4 is a flowchart showing one example of a flow of processing by the planning apparatus according to the embodiment.

### DESCRIPTION OF EMBODIMENTS

Hereinafter, with reference to the drawings, an embodiment of the present disclosure will be described.

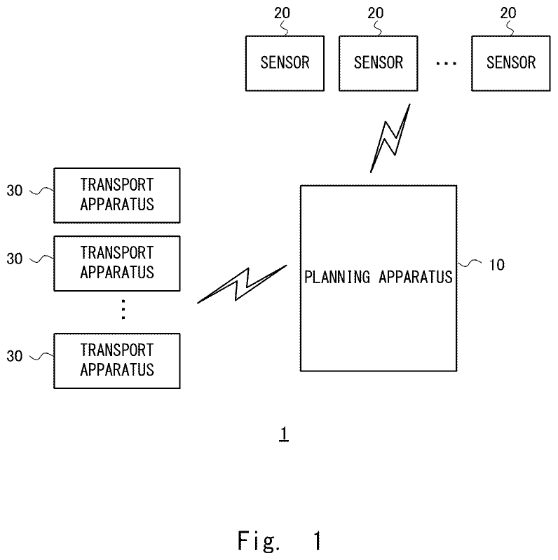

FIG. 1 is a schematic view showing one example of a system configuration of a collection system 1 according to the embodiment. The collection system 1 includes a planning apparatus 10, sensors 20, and transport apparatuses 30. The collection system 1, which is a system for making a plan to collect collection target objects from collection sites by the transport apparatuses 30, is also referred to as a planning system. In the collection system 1, the planning apparatus 10 is connected to each of the sensors 20 in such a way that they can communicate with each other. The planning apparatus 10 is also connected to each of the transport apparatuses 30 as necessary in such a way that they can communicate with each other.

While the collection target objects are garbage in this embodiment, they are not limited to being garbage and may be any objects of multiple types. The garbage here is not limited to garbage that has no utility value and may include garbage such as recyclable waste that has utility value.

The transport apparatus 30 is an apparatus that moves to the collection sites and transports garbage (collection target objects) collected from the collection sites. The transport apparatus 30 may be an autonomous mobile robot that autonomously moves or a vehicle such as a truck that a person drives.

The collection system 1 includes, for example, a plurality of types of transport apparatuses 30 having different abilities in transporting objects to be collected. The abilities in transporting the objects to be collected may be a transport volume, the types of the collection target objects that can be transported, or processing that can be performed on the collection target objects loaded on the transport apparatus 30 (e.g., compression processing, deodorization processing etc.)

When the transport apparatus 30 is an autonomous mobile robot, any known technique can be used for a moving method. The transport apparatus 30 may be, for example, an autonomous mobile robot that travels on the ground or may be an autonomous mobile robot that flies in the air.

The collection sites, that is, places that the transport apparatus 30 should visit to collect the collection target objects are, for example, a plurality of places. These places may be, for example, various places in a city or various places in one building such as a house. The transport apparatus 30 moves to the collection sites to collect the garbage (collection target objects) that is present at the collection sites.

The sensor 20, which is a sensor that senses garbage (collection target objects) that is present at each collection site, detects collection target object information. The collection target object information here means information regarding the type and the amount of the garbage (collection target objects). For example, by using the sensor 20, the type of the garbage and its amount such as an amount of combustible waste, an amount of non-combustible garbage, an amount of plastic bottles, and an amount of empty cans are detected.

The sensor 20 may be mounted on an autonomous mobile robot for detecting the collection target object information that moves in a range including the collection sites, mounted on an autonomous mobile robot capable of performing both the detection of the collection target object information and the collection of the collection target objects, or mounted on a collection box (garbage box) installed at a collection site. Since the sensor 20 is mounted on an autonomous mobile robot, the planning apparatus 10 that will be described later is able to acquire the collection target object information even when equipment for transmitting this information is not provided in each collection site.

The sensor 20 detects the amount and the type of the garbage using any known sensor technique. The sensor 20 may detect them by combining a plurality of sensor techniques. For example, in order to detect the amount of garbage, the sensor 20 may measure the weight of the garbage or the volume of the garbage. The volume of the garbage may be estimated by performing image recognition on a captured image of the garbage that is present at a collection site. That is, the sensor 20 may include a camera (image sensor). Further, when the amount of garbage can be counted as the number of objects having a predetermined size, like in a case in which the garbage is put in a bag, the sensor 20 may count this number. When the sensor 20 is mounted on a collection box (garbage box), this counting may be performed every time an object is put into the collection box. When the sensor 20 is mounted on an autonomous mobile robot, for example, the number of objects that are present at a collection site may be counted by image recognition performed on a captured image of the garbage that is present at the collection site. Further, when the sensor 20 mounted on the autonomous mobile robot detects the amount of garbage by measuring the weight of the garbage, this autonomous mobile robot may include a mechanism for lifting the garbage to measure the weight of the garbage.

Further, in order to detect the type of the garbage, the sensor 20 may specify to which type of garbage a container (e.g., a garbage box or a bag) that contains the garbage is dedicated. The sensor 20 specifies, for example, that the type of the garbage contained in a garbage box or a bag dedicated to combustible waste is combustible waste. To which type of garbage the container that contains the garbage is dedicated may be specified by detecting the features of the container associated with the type of garbage by an image sensor. These features may be, for example, a code (e.g., a two-dimensional code) attached to the container or the color of the container. The sensor 20 mounted on the autonomous mobile robot may detect, for example, that the garbage in the container is combustible waste by reading the two-dimensional code of the container. Alternatively, the sensor 20 mounted on the autonomous mobile robot may detect, for example, that the garbage in the container is combustible waste by reading the color of the container. In this manner, the sensor 20 may include an image sensor and the types of the collection target objects may be determined using this image sensor. According to the above structure, it is possible to easily specify the types of the collection target objects.

Note that the aforementioned features of the container are merely examples and other features of the container that can be associated with the type of the garbage may instead be used. Further, when the sensor 20 is mounted on the garbage box dedicated to a predetermined type of garbage, the determination on the features of the container to specify the type of the garbage may be omitted since the type of the garbage whose amount has been detected by the sensor 20 has already been known.

The method of detecting the collection target object information (the amounts and the types of the collection target objects) described above is merely one example and the detection may be performed by another method. The sensor 20 transmits the detected collection target object information to the planning apparatus 10.

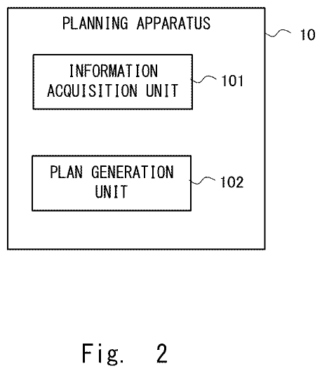

Next, the planning apparatus 10 will be described. FIG. 2 is a block diagram showing one example of a functional configuration of the planning apparatus 10. As shown in FIG. 2, the planning apparatus 10 includes an information acquisition unit 101 and a plan generation unit 102.

The information acquisition unit 101 acquires information regarding the type and the amount of the garbage (collection target objects) at a collection site, i.e., the aforementioned collection target object information, using the sensor 20. While the information acquisition unit 101 acquires the collection target object information by receiving it from the aforementioned sensor 20 in this embodiment, the information acquisition unit 101 may acquire this collection target object information via another apparatus.

The information acquisition unit 101 may acquire the collection target object information by performing analysis processing on the information received from the sensor 20 or the like. The information acquisition unit 101 may analyze the type and the amount of the garbage by performing known image recognition processing on the image received from the sensor 20.

According to this embodiment, in order to make a plan of a collection route, the information acquisition unit 101 acquires collection target object information for each collection site. That is, the information acquisition unit 101 acquires the collection target object information associated with the collection site. Therefore, the information acquisition unit 101 specifies at which place on the map (which collection site) the collection target object information has been acquired. When the information acquisition unit 101 has acquired positional information on a point regarding the collection target object information along with the collection target object information, the information acquisition unit 101 associates the collection target object information with the point on the map using the positional information. When, for example, the sensor 20 mounted on the autonomous mobile robot detects the collection target object information, this autonomous mobile robot transmits the position where the collection target object information has been detected to the planning apparatus 10. Accordingly, the information acquisition unit 101 may acquire positional information regarding the point where the collection target object information is detected along with the collection target object information. Further, for the sensor 20 mounted on a collection box (garbage box) installed at the collection site, the information acquisition unit 101 may specify at which place on the map (which collection site) the collection target object information has been acquired based on installation position information of a collection box specified in advance (installation position information of the sensor). When a plan of the collection route is not made, the information acquisition unit 101 may acquire collection target object information in which collection target object information of each collection site has been collected.

The plan generation unit 102 generates a plan to collect the collection target objects based on the acquired collection target object information. The plan generation unit 102 generates, for example, a collection route for collecting collection target objects of the same type based on the collection target object information. That is, the plan generation unit 102 may generate the collection route as a plan to collect the collection target objects. Specifically, for example, the plan generation unit 102 refers to the type of the garbage that is present at each collection site and generates a collection route for collecting garbage of the same type (e.g., combustible waste). The plan generation unit 102 calculates, for example, a route (e.g., shortest route) for efficiently collecting garbage of the same type using a known algorithm or the like. When the moving distance exceeds a predetermined threshold, the plan generation unit 102 may generate a plurality of collection routes so that the collection operation can be shared among a plurality of transport apparatuses 30.

As described above, since the plan generation unit 102 generates the collection route based on the collection target object information, a collection route in view of the information regarding the collection target objects at each collection site is generated. Therefore, it is possible to perform efficient movement for collection.

Further, the plan generation unit 102 may make a plan regarding which transport apparatus 30 to use for the collection. That is, the plan generation unit 102 may determine the type of the transport apparatus 30 used to collect collection target objects based on the collection target object information. With regard to this, the plan generation unit 102 may determine which one of a plurality of types of transport apparatuses 30 with different transport volumes should be used, or may determine which one of a plurality of types of transport apparatuses 30 that can transport different types of collection target objects (garbage) should be used. Further, the plan generation unit 102 may determine which one of a plurality of types of transport apparatuses 30 that perform different processing on the collection target objects loaded on the transport apparatuses 30 should be used. The plan generation unit 102 grasps, for example, the amount of the garbage for each type based on the collection target object information and specifies, for each type of garbage, the transport apparatus 30 capable of transporting the garbage of each type. Specifically, the plan generation unit 102 grasps the amount of the garbage for each type based on the collection target object information and allocates the transport apparatus 30 with a sufficient transport volume to each type. Further, when the garbage to be collected is a type of garbage required to be transported while it is subjected to predetermined processing (e.g., compression processing, deodorization processing or the like), the plan generation unit 102 determines to transport the above garbage by a transport apparatus 30 having the above function.

As described above, the plan generation unit 102 determines the type of the transport apparatus 30 to be used for collection based on the collection target object information, whereby the type of the transport apparatus 30 is determined in view of the information regarding the collection target objects. Therefore, it is possible to perform collection using an appropriate transport apparatus 30. Specifically, for example, it is possible to perform collection using a transport apparatus 30 with an appropriate transport volume or perform collection using a transport apparatus 30 that includes an appropriate processing function.

Further, the plan generation unit 102 may make a plan of the number of transport apparatuses 30 to be used for the collection. Specifically, the plan generation unit 102 may determine the number of transport apparatuses 30 to be used to collect the collection target objects based on the collection target object information. When, for example, the total amount of combustible waste exceeds the maximum transport volume of one transport apparatus 30 for combustible waste, the plan generation unit 102 determines to use a plurality of transport apparatus 30 for combustible waste so that all the garbage can be transported.

As described above, the plan generation unit 102 determines the number of transport apparatuses 30 based on the collection target object information, whereby the number of transport apparatuses 30 is determined in view of the information regarding the collection target objects. Therefore, it is possible to perform collection using an appropriate number of transport apparatuses 30.

Further, the plan generation unit 102 may make a plan regarding the frequency of the collection of the collection target objects. That is, the plan generation unit 102 may determine, based on the collection target object information, the frequency with which the collection target objects are collected. For example, the plan generation unit 102 makes a plan regarding the frequency of the collection for each type of garbage based on the amount of the garbage for each type of garbage. Specifically, for example, the plan generation unit 102 increases the frequency of garbage being collected as the amount of garbage increases. According to the above structure, it is possible to collect garbage at an appropriate frequency.

While the plan generated by the plan generation unit 102 has been described above, the plan generation unit 102 may make any one of the aforementioned various plans or a plurality of plans combined with each other.

The plan generation unit 102 may make a plan of, for example, only the collection route or may make both the plan of the collection route and the plan of the transport apparatus 30 used for collection.

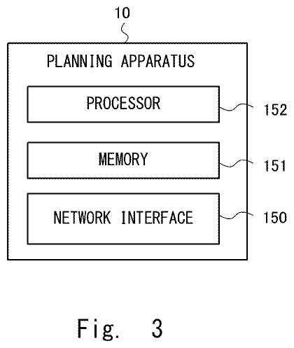

Next, one example of a hardware configuration of the planning apparatus 10 will be described. FIG. 3 is a block diagram showing one example of the hardware configuration of the planning apparatus 10. As shown in FIG. 3, the planning apparatus 10 includes a network interface 150, a memory 151, and a processor 152. The network interface 150, the memory 151, and the processor 152 are connected to one another via a data bus.

The network interface 150 is used to communicate with any other device such as a sensor 20. The network interface 150 may include, for example, a network interface card (NIC).

The memory 151 is composed of, for example, a volatile memory and a non-volatile memory. The memory 151 is used to store software (computer program) that includes one or more instructions and is executed by the processor 152, data to be used for various kinds of processing of the planning apparatus 10 and the like.

The processor 152 loads software (computer program) from the memory 151 and executes the loaded software (computer program), thereby performing processing of the aforementioned planning apparatus 10.

The processor 152 may be a microprocessor, a Micro Processor Unit (MPU), a Central Processing Unit (CPU) or the like. The processor 152 may include a plurality of processors.

The planning apparatus 10, which is an apparatus that functions as a computer, is also referred to as an information processing apparatus.

Further, the above-described program can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), CD-Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

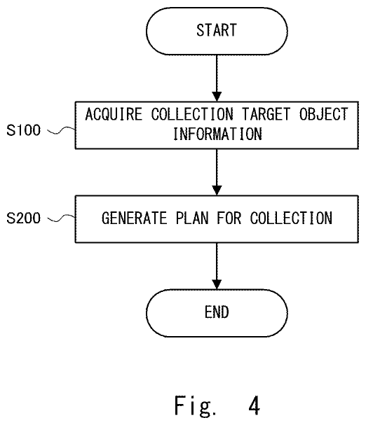

Next, a flow of processing performed by the planning apparatus 10 will be described. FIG. 4 is a flowchart showing one example of a flow of processing performed by the planning apparatus 10. In the following, with reference to the flowchart, the flow of the processing will be described.

In Step S100, the information acquisition unit 101 acquires the collection target object information using the sensor 20. Note that this acquisition may be periodically performed.

Next, in Step S200, the plan generation unit 102 generates a plan to collect the collection target objects based on the collection target object information acquired in Step S100. Specifically, the plan generation unit 102 may make a plan of, for example, a collection route, a transport apparatus 30 to be used for collection, and the frequency of the collection. Accordingly, the collection in accordance with the plan generated by the plan generation unit 102 is performed by the transport apparatus 30. As described above, the transport apparatus 30 may be an autonomous mobile robot or may be a truck driven by a person. Therefore, the plan generated by the plan generation unit 102 may be used for an automatic collection by an apparatus or may be used for a collection operation by a person. Note that the plan generation unit 102 may output the planned content, which is the generated plan data, to another apparatus. The other apparatus may be a transport apparatus 30 or a server of a cleaning company.

The embodiment has been described above. According to this embodiment, the collection target object information is acquired and a collection plan in view of the information regarding the collection target objects is generated. Therefore, an efficient collection of collection target objects in accordance with the type or the amount thereof can be achieved.

Note that the present disclosure is not limited to the above-described embodiment and may be changed as appropriate without departing from the spirit of the present disclosure.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A planning system for making a plan to collect collection target objects from a collection site, the planning system comprising:
an information acquisition unit configured to acquire, using a sensor, collection target object information, which is information regarding types and amounts of the collection target objects that are present in the collection site; and
a plan generation unit configured to generate a plan to collect the collection target objects based on the collection target object information.

2. The planning system according to claim 1, wherein
the information acquisition unit acquires the collection target object information for each collection site, and
the plan generation unit generates a collection route for collecting the same type of collection target objects based on the collection target object information.

3. The planning system according to claim 1, wherein the plan generation unit determines, based on the collection target object information, a type of a transport apparatus that is used to collect the collection target objects, the transport apparatus moving to the collection site and transporting the collection target objects collected from the collection site.

4. The planning system according to claim 3, wherein the plan generation unit determines which one of a plurality of types of transport apparatuses with different transport volumes should be used.

5. The planning system according to claim 3, wherein the plan generation unit determines which one of a plurality of types of transport apparatuses that perform different processing on the collection target objects loaded on the transport apparatuses should be used.

6. The planning system according to claim 1, wherein the plan generation unit determines, based on the collection target object information, the number of transport apparatuses that are used to collect the collection target objects, the transport apparatuses moving to the collection site and transporting the collection target objects collected from the collection site.

7. The planning system according to claim 1, wherein the plan generation unit determines, based on the collection target object information, a frequency with which the collection target objects are collected.

8. The planning system according to claim 1, wherein the sensor is mounted on an autonomous mobile robot that moves in a range including the collection site.

9. The planning system according to claim 8, wherein the sensor comprises an image sensor, and the types of the collection target objects is determined using the image sensor.

10. A planning method in which an information processing apparatus makes a plan to collect collection target objects from a collection site, the method comprising:
acquiring, using a sensor, collection target object information, which is information regarding types and amounts of the collection target objects that are present in the collection site; and
generating a plan to collect the collection target objects based on the collection target object information.

11. A non-transitory computer readable medium storing a program for causing a computer that makes a plan to collect collection target objects from a collection site to perform the following:
acquiring, using a sensor, collection target object information, which is information regarding types and amounts of the collection target objects that are present in the collection site; and
generating a plan to collect the collection target objects based on the collection target object information.
